(19) United States
(12) Patent Application Publication
(10) Pub. No.: US 2021/0062381 A1
(43) Pub. Date: Mar. 4, 2021

(54) METHODS OF PRETREATING HYDROPHOBIC FABRICS PRIOR TO PRINTING

(71) Applicant: Polymeric Ireland Limited, Dublin (IE)

(72) Inventors: Pramudi Abeydeera, Kansas City, MO (US); Deverakonda Sarma, Kansas City, MO (US)

(21) Appl. No.: 17/013,440

(22) Filed: Sep. 4, 2020

Related U.S. Application Data
(60) Provisional application No. 62/895,609, filed on Sep. 4, 2019.

(51) Int. Cl. D06B 11/00; D06P 5/30; B41J 3/407; B41J 11/00

(52) U.S. Cl. CPC D06B 11/0059; B41J 11/002; B41J 3/4078; D06P 5/30

(57) ABSTRACT

Provided herein are processes and methods of pretreating a fabric (such as hydrophobic fabric) prior to the application of graphics using, for example, inkjet printing. The process may comprise, for example, applying a pretreatment composition to at least a portion of the bottom face of a textile, thereby causing the pretreatment composition to migrate to the top face of the textile via capillary action. The process may further comprise a printing step wherein one or more inks are applied to the top face of a textile, thereby forming a graphical image on the textile.

### CROSS-REFERENCE TO RELATED APPLICATION

This Application claims the priority benefit of U.S. Provisional Patent Application Ser. No. 62/895,609, filed on Sep. 4, 2019, entitled “Methods of Pretreating Hydrophobic Fabrics Prior to Printing,” currently pending, the entire disclosure of which is incorporated herein by reference.

### FIELD

The present disclosure is generally directed to processes and methods of pretreating a hydrophobic fabric prior to the application of graphics using, for example, inkjet printing. Also included is the design of new platen for the application of same.

### BACKGROUND

Inkjet printing is a useful technique for applying graphics to a wide variety of substrates, including fabrics. For example, graphics are commonly applied to tee-shirts using a technique known as “direct printing,” which utilizes water-based pigment inks containing various resin compositions.

In a conventional direct printing process, an aqueous pretreatment composition is applied to at least a portion of the textile material that is to receive the ink image. The pretreatment composition typically comprises one or more polymer resins, and often includes other additives such as salts, surfactants, defoamer, adhesion promoter, coalescing solvent, and the like. Typically, the textile material containing the pretreatment composition is heated so as to remove moisture from the pretreatment composition and react the one or more polymer resins with the one or more other compounds thereby forming an image-receiving layer on the textile material. Following the pretreating step, white ink layer is typically deposited first on the pretreatment layer before printing with color inks (cyan, magenta, yellow, black and other spot colors based on the type of the printer).

The direct printing process often works well with fabrics composed of 100% cotton, as well as many cotton/polyester blends. Unfortunately, on synthetic substrates like 100% polyester, nylon, or other synthetic blends, conventional direct printing processes does not yield better color density either due to dye migration or lack of absorption of pretreatment by the fabric material. Due to a hydrophobic nature of the synthetic fabric, water-based pretreatment/coatings will flow through the fabric thereby retaining less amount of pretreatment. In case the of a hydrophilic fabric, such as 100% cotton, the hydrophilic pretreatment/coating is well absorbed thereby yielding better color density and other print properties.

In some situations, the substrate or item intended to receive an image is not amenable to direct printing operations. In other situations, the volume of images to be printed makes direct printing operations economically unfeasible. It may also be desirable for printing operations to be performed at a site remote from the products to which the images will be applied. To address these issues, the textile and clothing industry has used ink transfers as a way of applying an image to, for example, an article of clothing. For example, U.S. Pat. No. 8,815,040, the entirety of which is incorporated herein by reference, is directed toward an ink transfer system for transferring ink images to synthetic textile materials.

Dye sublimation transfers have also been shown to provide certain benefits as compared to direct-to-substrate printing and other types of image transfer systems, particularly in regard to fabrics. Dye sublimation transfers are created by laying down reversed imagery onto transfer paper using dye-containing inks (as opposed to the pigmented inks that are conventionally used in direct printing systems). In a conventional dye sublimation process, the fabric and transfer paper are pressed together under high heat, typically 400° F., which causes the dyes contained within the inks to flash sublimate. The vapor-phase dyes then migrate into the fabric's fibers, thereby transferring the image from the transfer to the fabric.

Dye sublimation has the ability to provide vibrant colors and transfer of highly detailed images that are limited only by the texture of the fabric and the resolution of the printer used in the manufacture of the transfer. Unfortunately, however, conventional dye sublimation processes do not work well in all fabric applications. For example, while dye sublimation can be used on cotton-containing fabrics to initially transfer an image to the fabric, the dyes generally do not adhere well to the cotton fibers. As a result, the transferred image is not durable, the image quality is poor, and the image may degrade very quickly, often upon a single wash cycle. Additionally, dye sublimation printing is not possible on darker colored fabrics, such as tee-shirts, and is therefore significantly limited in its applications.

Accordingly, there is a need in the art for a method that permits use of direct printing on a wide variety of substrates, including both hydrophilic and hydrophobic fabrics (e.g., cotton, polyester, nylon, and blends of these and other materials).

### SUMMARY

Provided herein is a method for creating a printed textile comprising a graphical image, the method including a pretreatment step wherein a pretreatment composition is applied to at least a portion of the bottom face of a textile; and a printing step wherein one or more inks are applied to the top face of a textile, thereby forming a graphical image on the textile.

Further provided herein is a printed textile comprising a graphical image, wherein said printed textile is prepared according to a method as disclosed herein.

These and other aspects of the present disclosure are described in further detail below.

### DESCRIPTION OF THE FIGURES

FIG. 1 illustrates a pair of polyester fabric samples processed with a pretreatment step, as described in Example 1, wherein a pretreatment composition (having a 5-20% resin concentration) was applied to the fabric. The sample on the left was prepared by applying the pretreatment composition to the top face of the fabric, while the sample on the right was prepared by applying the pretreatment composition to the bottom face of the fabric.

FIG. 2 illustrates a pair of polyester fabric samples processed with a pretreatment step, as described in Example 1, wherein a pretreatment composition (having a 10% resin concentration) was applied to the fabric. The sample on the left was prepared by applying the pretreatment composition to the top face of the fabric, while the sample on the right was prepared by applying the pretreatment composition to the bottom face of the fabric.

FIG. 3A is a schematic sectional view of a bilayer formation on a substrate in accordance with one embodiment of the present invention.

FIG. 3B is a schematic sectional view of a monolayer formation on a substrate in accordance with one embodiment of the present invention.

FIG. 4A is a photographic perspective view of a platen without a tee-shirt loaded thereon in accordance with one embodiment of the present invention.

FIG. 4B is a photographic perspective view of a platen with a tee-shirt loaded thereon in accordance with one embodiment of the present invention.

FIG. 5A is a schematic sectional view of an existing platen for use in textile printing as is currently known in the art; and

FIG. 5B is a schematic sectional view of new platen design for use in textile printing that is configured for applying a pretreatment composition to a textile in accordance with one embodiment of the present invention.

### DETAILED DESCRIPTION

Provided herein are processes and methods for applying graphics to fabrics. The methods provided herein include a pretreatment step on hydrophobic fabrics, such as 100% polyester and the like, to address the print quality and adhesion issues conventionally associated with water-based pigment inks that are described in detail above.

The method provided herein may comprise applying a pretreatment composition to a fabric by spraying or otherwise applying the pretreatment composition to a first face (e.g., the bottom face) of the fabric. Without being bound to a particular theory, it is believed that the pretreatment composition, when applied in this manner, migrates to an opposing second face (e.g., the top face) of the fabric (i.e., the face of the fabric to be printed) via capillary action. As described in further detail below, it has been discovered that this method of application provides several advantages relative to spraying the top face of the fabric directly.

The methods provided herein may be used to apply graphics to any suitable fabric known to those skilled in the art. Non-limiting examples of fabrics that may be printed using the provided methods include cotton, polyester, nylon, and blends of these and other materials. The materials may be hydrophilic or hydrophobic. For example, the method may comprise applying graphics to a textile that includes polyester fabric.

It will be appreciated that the methods provided herein may be adapted for various applications. The entire disclosure of U.S. Patent Application Ser. No. 62/881,092 filed on Jul. 31, 2019 to Pramudi Abeydeera and Deverakonda Sarma, entitled “Methods of Preconditioning Fabric Prior to Inkjet Printing,” is incorporated herein by reference.

### Pretreatment Step

The methods provided herein include a pretreatment step comprising applying a pretreatment composition to all or a portion of the textile. The pretreatment step may further comprise heating or drying the textile at an elevated temperature.

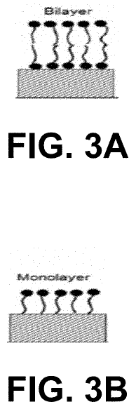

The pretreatment composition may be applied to the textile by any means known in the art. For example, the pretreatment composition may be applied to the textile by spraying (e.g., using a valve jet nozzle) or with an inkjet printhead. In one embodiment, the pretreatment composition is applied to the textile by spraying or soaking the bottom face of the fabric. In another example, the fabric is treated such that the hydrophobic nature of the surface is converted to a hydrophilic nature so as to absorb the water-based, pretreatment. Surfactants form a monolayer or a bilayer onto surfaces based on the surfactant concentration in solution and the nature of the substrates (see FIG. 3). This technique can be used to change the surface nature of the fabric in order better absorb or retain the pretreatment solution of choice. Once it is dried, the pretreatment solution can form a layer on the surface thereby retaining other layers deposited on the surface.

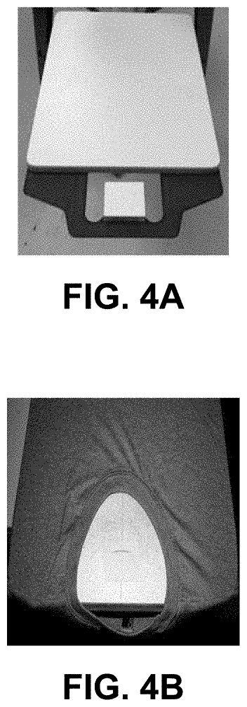

Alternatively, the pretreatment composition may be applied to the textile by a means other than spraying. For example, the bottom face of the fabric may be contacted or immersed in the pretreatment composition. In one embodiment, the fabric is wrapped around or otherwise placed on a platen (see FIG. 4B), whereby the platen is configured for applying the pretreatment composition to the bottom face of the fabric (i.e., the face of the fabric that is in contact with the platen). In another embodiment, the fabric is laid on a tray or basin comprising the pretreatment composition, such that the bottom face of the fabric contacts the pretreatment solution, and the pretreatment solution migrates to the top face of the fabric via capillary action. In a further embodiment, the bottom face of the fabric is contacted with a sponge or sponge-like material that has been soaked with the pretreatment solution.

The pretreatment composition may be applied to the entire textile or a portion thereof. Preferably, the pretreatment composition is applied only to selected portions of the fabric (e.g., those portions where a graphical image will subsequently be applied). The pretreatment solution consists of a hydrophobic, acrylic latex emulsion that can be heat activated with glass transition temperature (Tg) below −0° C. Lower glass transition temperature of the resin yields soft hand desirable for the fabric printing. In one embodiment, the pretreatment composition has a glass transition temperature between about −10 and about −55° C. in one embodiment or between about −10 and about −35° C. in another embodiment, and has excellent salt, mechanical and heat stability. In addition to resin, the pretreatment solution can have a salt, defoamer, an adhesion promoter, and surfactants to improve wettability of the fabric.

The pretreatment step may comprise heating or drying the textile at an elevated temperature. For example, the textile may be dried at a temperature of at least about 200° F., at about 230° F., at least about 250° F., at least about 260° F., at least about 270° F., at least about 280° F., at least about 290° F., at least about 300° F., at least about 310° F., or at least about 320° F. In some embodiments, the textile may be dried at a temperature of from about 200° F. to about 400° F., for example from about 250° F. to about 425° F., from about 300° F. to about 375° F., or from about 320° F. to about 350° F. The textile may be dried at one or more of the temperatures listed above for a period of at least about 15 seconds, at least about 30 seconds, at least about 45 seconds, at least about 1 minute (i.e., 60 seconds), at least about 1 minute 15 seconds (i.e., 75 seconds), or at least about 1 minute 30 seconds (i.e., 90 seconds). For example, the textile may be dried for a period of from about 30 seconds to about 15 minutes, from about 30 seconds to about 5 minutes, from about 1 minute to about 3 minutes, or from about 1 minute to about 2 minutes. In one embodiment, the pretreatment step comprises drying the textile at a temperature of at least about 230° F. for a period of at least about 90 seconds. The time of drying/curing can depend on the temperature of the oven in which it is cured. Due to dye migration issues with polyester fabrics, it is often required to dry/cure at a relatively low temperature for a longer time.

### Printing Steps

Following the pretreatment step, graphics may be applied to the textile using one or more printing steps. For example, graphics may be applied to the textile using conventional inkjet printing techniques. The printing steps may include one or more of: (1) application of a white ink composition; (2) application of one or more colored inks; and/or (3) application of a top coating.

White Ink Application

The method may further comprise a step wherein a white ink layer is applied to the textile. For example, the white ink layer may be applied to the portion of the textile that is to be printed using an inkjet nozzle. Once the white ink layer has been applied, the textile may be subjected to an additional drying step. For example, the textile may be dried using infrared (IR) lamps.

Colored Ink Application

The method may further comprise a step wherein colored inks are applied to the textile. Typically, the colored inks may be applied using an inkjet nozzle. Once the colored inks been applied, the textile may be subjected to an additional drying step. For example, the textile may be dried using infrared (IR) lamps.

Top Coat Application

The method may further comprise a step wherein colored inks are applied to the textile. The top coating may be applied, for example, using an inkjet nozzle or a valve jet nozzle.

### Curing Step

The method may further comprise a curing step wherein the printed textile is subjected to an elevated temperature. For example, the textile may be cured at a temperature of at least about 200° F., at least about 250° F., at least about 260° F., at least about 270° F., or at least about 280° F. In some embodiments, the textile may be cured at a temperature of from about 200° F. to about 400° F., for example from about 200° F. to about 300° F., from about 250° F. to about 350° F., from about 270° F. to about 320° F., or from about 280° F. to about 300° F. The textile may be cured at one or more of the temperatures listed above for a period of at least about 15 seconds, at least about 30 seconds, at least about 45 seconds, at least about 1 minute (i.e., 60 seconds), at least about 1 minute 15 seconds (i.e., 75 seconds), or at least about 1 minute 30 seconds (i.e., 92 seconds). For example, the textile may be cured at an elevated temperature for a period of from about 30 seconds to about 60 minutes, from about 1 minute to about 15 minutes, from about 1 minute to about 10 minutes, from about 4 minutes to about 8 minutes, or from about 8 minutes to about 12 minutes. In one embodiment, the curing step comprises heating the printed textile at a temperature of from about 200° F. to about 300° F. for a period of between about 30 seconds and about 12 minutes.

### Printed Textile

Also provided is a printed textile comprising a graphical image that is prepared using a method as described above.

In preferred embodiments, the printed textile is capable of withstanding at least 5, at least 10, at least 15, or at least 25 washing cycles while still exhibiting only minor amounts of fading of the graphical image.

Preferably, the graphical image remaining after the washing cycles is considered industrially acceptable and retains at least about 70% of the original color density as measured by a spectro-densitometer (for example, at least about 80%, at least about 90%, or at least about 95% of the original color density) even after 5, 10, 15, or 25 washing cycles.

Preferably, the printed textile avoids discernable yellowing or staining of the textile material upon heating and curing of the applied graphics composition, with or without application of a top coat.

Platen Design (For Soaking the Fabric from Back Side)

Also provided herein is a platen for use in textile printing processes. The platen may be used, for example, in the processes and methods provided herein. Advantageously, the platen provided herein comprises a hollow tray that can be filled, for example, a pretreatment solution as described herein. When a textile is loaded on the platen, the bottom face of the textile contacts the pretreatment solution. Without being bound to a particular theory, it is believed that this allows the pretreatment solution to migrate to the top face of the textile via capillary action, as described in further detail above. While the pretreatment is held by the fabric due to capillarity, the same pretreatment will be sprayed, jet/print through a drop on demand printhead/valvej et and dried before it was further processed for printing.

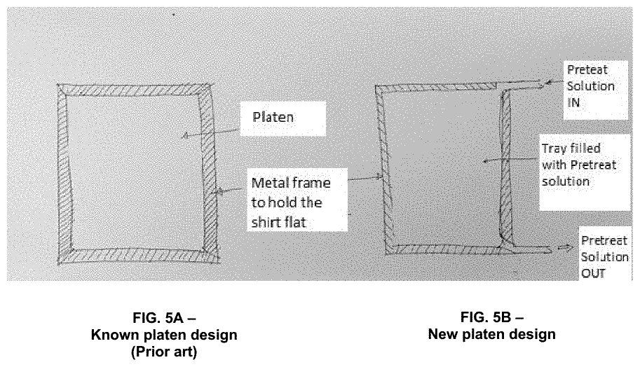

An exemplary embodiment of a platen as described herein is depicted in FIGS. 4A, 4B and 5B.

Currently-known platens, as illustrated in FIG. 5A, include a flat substrate with a metal frame to hold one of the tee-shirt layer (top or bottom based on where to print) with the other layer below the platen. With currently-known platens, pretreatment is sprayed or printed and dried before it is further processed to print with white and colored inks.

In order to pretreat from the bottom of a layer, the new platen design, as illustrated in FIG. 5B, includes a tray that can hold the pretreatment so the fabric layer may absorb the pretreatment from below and hold it by capillary action. The tray can be filled manually or pumped in and out by mechanical means to fill the tray with pretreatment solution.

Other objects and features will be in part apparent and in part pointed out hereinafter.

### EXAMPLES

The following non-limiting examples are provided to further illustrate the present disclosure.

### Example 1

The components described below were used in each of the following examples, unless otherwise indicated.

The pretreatment composition used in the following examples was an aqueous formulation comprising an anionic, acrylic latex emulsion, salt, surfactant, adhesion promoter, and other additives. The fabric samples used in the following examples are described in Table 1 below.

TABLE 1

| Sample | Fabric Type | Fabric Color |
|---|---|---|
| 1 | 100% polyester tee-shirt | Red |
| 2 | 100% polyester tee-shirt | Red |
| 3 | 100% polyester tee-shirt | Red |
| 4 | 100% polyester tee-shirt | Red |

### Example 2

The fabric samples described in Example 1 were each subjected to pretreatment steps, as described in Table 2 below.

TABLE 2

| Sample | Pretreatment Step |
|---|---|
| 1 | Fabric was pretreated with pretreatment composition |
| | by spraying from the top. The pretreated sample was |
| | oven dried at 240-260° F. for 90 seconds, then cooled |
| | to room temperature. |
| 2 | Fabric was pretreated with pretreatment composition |
| | by spraying from the bottom. The pretreated sample was |
| | oven dried at 240-260° F. for 90 seconds, then cooled |
| | to room temperature. |
| 3 | Fabric was pretreated with pretreatment composition |
| | by spraying from the top. The pretreated sample was |
| | oven dried at 240-260° F. for 90 seconds, then cooled |
| | to room temperature. |
| 4 | Fabric was pretreated with pretreatment composition |
| | by spraying from the bottom. The pretreated sample was |
| | oven dried at 240-260° F. for 90 seconds, then cooled |
| | to room temperature. |

### Example 3

Following the pretreatment steps described in Example 2 above, the samples were exposed to room conditions (i.e., ambient temperature and humidity) and were then prepared for printing using an inkjet press. A white ink layer was applied to the top face of each sample and dried using an IR lamp. Next, a colored ink layer was applied to the top face of each sample, using either CMYK inks or CMYK, red and green inks based on the printer configuration. Some of the printers were equipped to lay down a top coat on the top of the printed layer; during these runs, the top coat was applied in-line with a sprayer or using a valve jet/inkjet printhead.

After completion of the printing process, each sample was sent through a convection oven set at 230° F. for 12 minutes. Once each sample was fully cured, the samples were examined for signs of dye migration. Each sample was then sent through a washing cycle to test for wash fastness of the applied graphics.

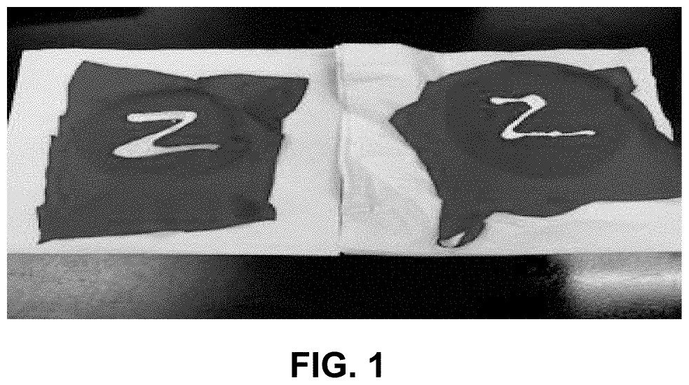

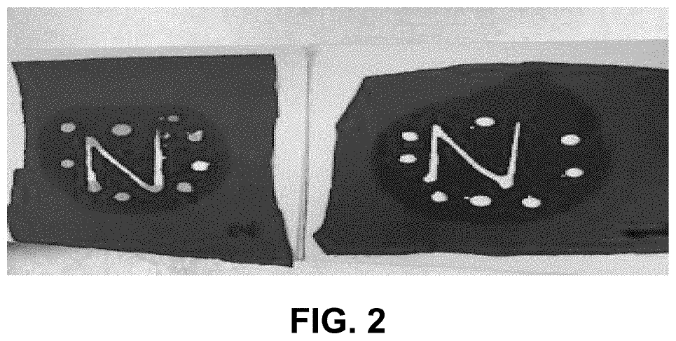

As shown in FIGS. 1 and 2, for the samples where the pretreatment composition was applied by spraying from the top (left sample in each figure), significant dye transfer to the white ink layer was visible. More specifically, it was observed that unreacted dye from the fabric mixed with the white ink layer and shifted the color, as shown in the figures.

As shown in FIGS. 1 and 2, for the samples where the pretreatment composition was applied by spraying from the bottom (right sample in each figure), no dye transfer was visible. Furthermore, the wash fastness of the fabrics was significantly improved, regardless of whether a top coat was applied. The finished textile products exhibited excellent washability characteristics, capable of withstanding at least five washing cycles (e.g., using a household washing machine and detergent) without any observable fading of the image.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method for creating a printed textile comprising a graphical image, the method comprising:
a pretreatment step for fabrics wherein a pretreatment composition is applied to at least a portion of a first face of a textile ; and
a printing step wherein one or more inks are applied to an opposing second face of the textile, thereby forming a graphical image on the textile.

2. The method of claim 1 wherein the first face is the bottom face of the textile and the second face is the top face of the textile.

3. The method of claim 1 wherein pretreatment step comprises spraying the first face of the textile with the pretreatment composition.

4. The method of claim 3 wherein the pretreatment composition is sprayed using a valve jet or printed with an inkjet printhead.

5. The method of claim 1 wherein the pretreatment step comprises immersing the first face of the textile in the pretreatment composition.

6. The method of claim 1 wherein the pretreatment step comprises contacting the first face of the textile with a sponge or sponge-like material, wherein the sponge or sponge-like material comprises the pretreatment composition.

7. The method of claim 1 wherein the pretreatment step further comprises drying the textile at an elevated temperature without dye migration or staining.

8. The method of claim 7 wherein the pretreatment step comprises drying the textile at a temperature of at least about 230° F. for a period of at least about 90 seconds.

9. The method of claim 1 wherein the printing step is an inkjet printing step wherein one or more inks are applied to the textile using an inkjet nozzle.

10. The method of claim 1 wherein the printing step comprises (1) applying one or more white ink layers to the top face of the textile, followed by (2) applying one or more colored ink layers to the top face of the textile.

11. The method of claim 1 further comprising a curing step, wherein the curing step comprises heating the printed textile at an elevated temperature.

12. The method of claim 11 wherein the curing step comprises heating the printed textile at a temperature of from about 200° F. to about 300° F. for a period of between about 30 seconds and about 12 minutes.

13. A printed textile prepared according to the method of claim 1.

14. The printed textile of claim 13 wherein said printed textile is capable of withstanding at least 10 washing cycles while still exhibiting only minor amounts of fading of the graphical image.

15. The printed textile of claim 13 wherein the graphical image retains at least about 70% of its original color density as measured by a spectro-densitometer after 10 washing cycles.

16. The printed textile of claim 13 wherein said printed textile avoids discernable yellowing of the textile material upon heating and curing of the applied graphics composition.

17. A platen useful to print an image on a textile, comprising:
a metal frame defining the exterior surface of the platen; and
a cavity comprising a pretreatment solution.

18. The platen of claim 17 further comprising an inlet in fluid communication with cavity configured such that the pretreatment solution may be pumped into the cavity.

19. The platen of claim 17 further comprising an outlet in fluid communication with cavity configured such that the pretreatment solution may be drained from the cavity.
